(19) United States
(12) Patent Application Publication
(10) Pub. No.: US 2006/0027108 A1
(43) Pub. Date: Feb. 9, 2006

(54) Method of measuring and cutting a food product and associated measuring and cutting guide

(76) Inventor: Toby N. Wolfe, Pittsburgh, PA (US)

Correspondence Address: ECKERT SEAMANS CHERIN & MELLOTT, 600 GRANT STREET, 44TH FLOOR, PITTSBURGH, PA, 15219, US

(21) Appl. No.: 10/913,826

(22) Filed: Aug. 6, 2004

(51) Int. Cl. A23N 4/04

(52) U.S. Cl. 99/537

(57) ABSTRACT

A method of cutting a food product in a pan having a base and upstanding sidewalls includes providing a cutting guide which is substantially rigid and placing the same in overlying relationship with the pan with a cutting guide flange engaging a sidewall of the pan. A plurality of first markings are provided adjacent the guide to establish references for cutting in a first direction. The cutting guide is then positioned in an orientation generally perpendicular to the first orientation with a series of cutting reference marks being established in the food product. The cutting guide is then employed to effect cutting along the reference marks in the first direction and subsequently in a second direction thereby facilitating removal of the cut food product portions from the pan. The cutting guide preferably has a plurality of reference marks to facilitate precise determination of the position at which cuts will be made. The method may be employed directly with a food product not in pan. The cutting guide is preferably substantially rigid and has a downwardly depending flange which engages a pan sidewall to facilitate the desired orientation and stability of the cutting guide when the marks are made in the food product.

### BACKGROUND OF THE INVENTION

1. Field of the Invention

The present invention relates to an improved method of measuring and cutting food products into desired portions and the associated measuring and cutting tool and more specifically, it relates to such a method and tool advantageously employable in a solid food product which may be disposed within a pan having upstanding sidewalls or may be measured and cut without being in a pan.

2. Description of the Prior Art

It has long been known to provide a wide variety of food products which are prepared in a pan having a base and upstanding sidewalls after which the food product which may, for example, be baked goods such as a cake or brownie or other food products such as lasagna or casseroles, for example, is to be cut into individual portions and removed from the pan for storage or immediate serving.

It has been known to effect such cutting manually without any assistance in terms of uniformity of size or shape of the individual portions other than the human eye, as a knife or other cutting implement is employed to sever the unitary food product into individual components.

The obvious ongoing problem with the prior art approach is that people are not capable of effecting said cutting with a reasonable degree of accuracy. This not only results in variation in sizes of the individual portions, but also leaves a final section with grossly undersized portions which do not approximate the size of the other portions.

There remains therefore, a very real and substantial need for an efficient means of effecting uniform division of a solid food product contained within a pan or without a pan into individual portions of general size and shape.

### SUMMARY OF THE INVENTION

The present invention has met the foregoing need by providing a measuring and cutting tool which effectively and simply facilitates cutting the solid food product into individual portions.

In a preferred practice of the method, a food product, as hereinafter defined, is severed into portions by providing a substantially rigid cutting guide having an elongated body and a depending flange. The cutting guide is positioned on a food product-containing pan in a first position on top of the pan adjacent a first sidewall thereof with the flange engaging an adjacent second sidewall. Markings are placed on the food product adjacent to the first sidewall at a plurality of spaced locations adjacent to the cutting guide. The cutting guide is then moved to an adjacent second position generally perpendicular to the first position with the flange engaging an adjacent sidewall and a second plurality of spaced marks are provided on the food product. The guide is then aligned sequentially (a) with the first or second spaced mark locations and (b) then with the other of the first or second spaced locations. The cutting of the food product along the cutting guide at the first said spaced mark locations and the second spaced mark locations generates the desired plurality of individual food portions of desired substantially uniform shape and size. The method may also be employed with a food product not in a pan in a similar manner. In a preferred embodiment, the cutting guide is provided with a series of reference marks which are generally uniformly spaced and preferably are adjacent both lateral edges of the cutting guide body portion to facilitate creating the first and second series of marks for cutting.

The cutting guide preferably is composed of metal or plastic and is substantially rigid to permit effective engagement between the flange and the pan and uniformity of marking.

It is an object of the present invention to provide a simple measuring and cutting guide and a method of using the same which will economically and easily facilitate a food product being cut in generally uniform individual pieces.

It is a further object of the present invention to provide a durable and simple cutting guide which may readily be stored in a residential or commercial kitchen to be used easily and be readily cleaned so as to provide for user safety.

It is yet another object of the present invention to provide such a cutting guide and method of use which would be economical to manufacture and durable in use.

It is another object of the present invention to provide such a guiding tool wherein the reference marks may be spaced predetermined distances apart and may provide ready measurement in the desired units of dimension.

These and other objects of the invention will be more fully understood from the following detailed description of the invention on reference to the illustrations appended hereto.

### BRIEF DESCRIPTION OF THE DRAWINGS

FIG. 1 is a front elevational view of a cutting guide of the present invention.

FIG. 2 is a left side elevational view of the cutting guide of FIG. 1.

FIG. 3 is a top plan view of the cutting guide of FIG. 1.

FIG. 4 is a top plan view of a form of rectangular pan usable with the present invention.

FIG. 5 is a cross-sectional view of FIG. 4 taken through 5-5 showing a section of the pan with a food product contained therein.

FIG. 6 is a perspective view showing the food product-containing pan and the cutting guide in a first position for making markings on the food product.

FIG. 7 is a perspective view showing a pan containing a food product to be severed with the cutting guide in a second position.

### DESCRIPTION OF THE PREFERRED EMBODIMENT

As employed herein, the term “pan” means a cooking vessel having a base and an upstanding continuous sidewall which may have at least one generally planar sidewall portion and shall expressly include, but not be limited to, such vessels having a square or rectangular configuration.

As employed herein, “food product” means a solid food which can be severed into smaller units by cutting and shall expressly include, but not be limited to, baked goods, candies, casseroles and noodle-containing foods.

In the present invention, the method employs a unique cutting guide which preferably has unitary construction and is rigid. It preferably is composed of a material selected from the group consisting of metal and plastic.

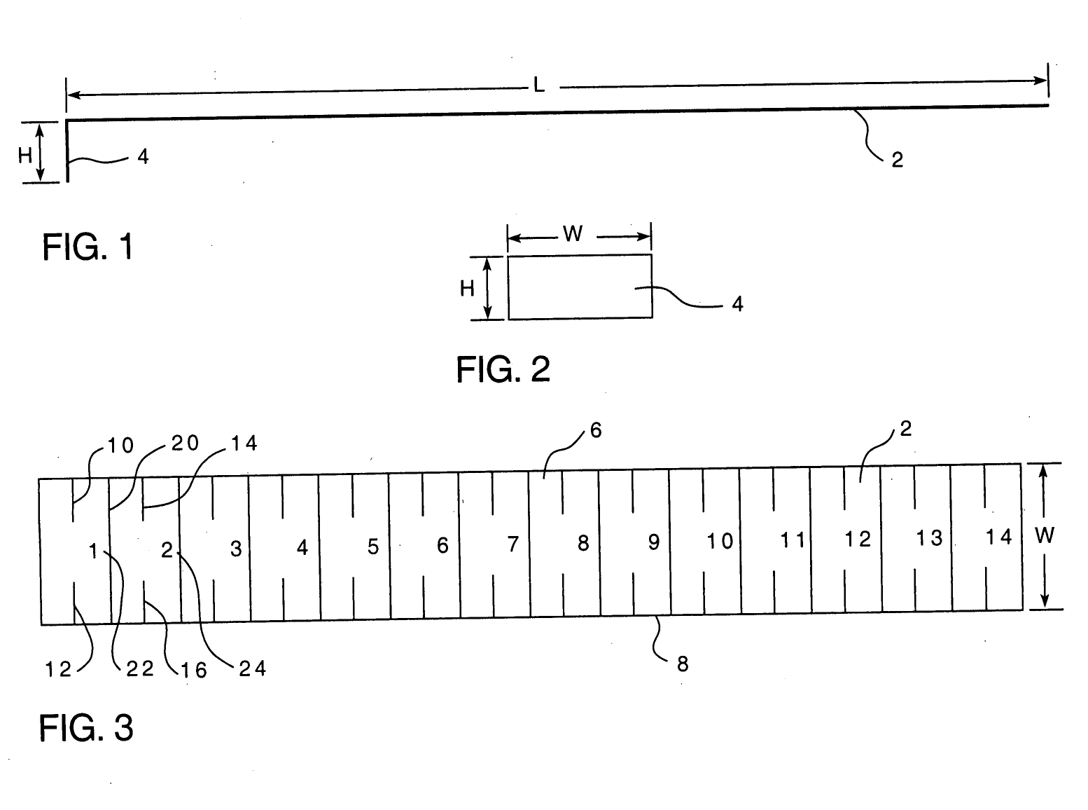

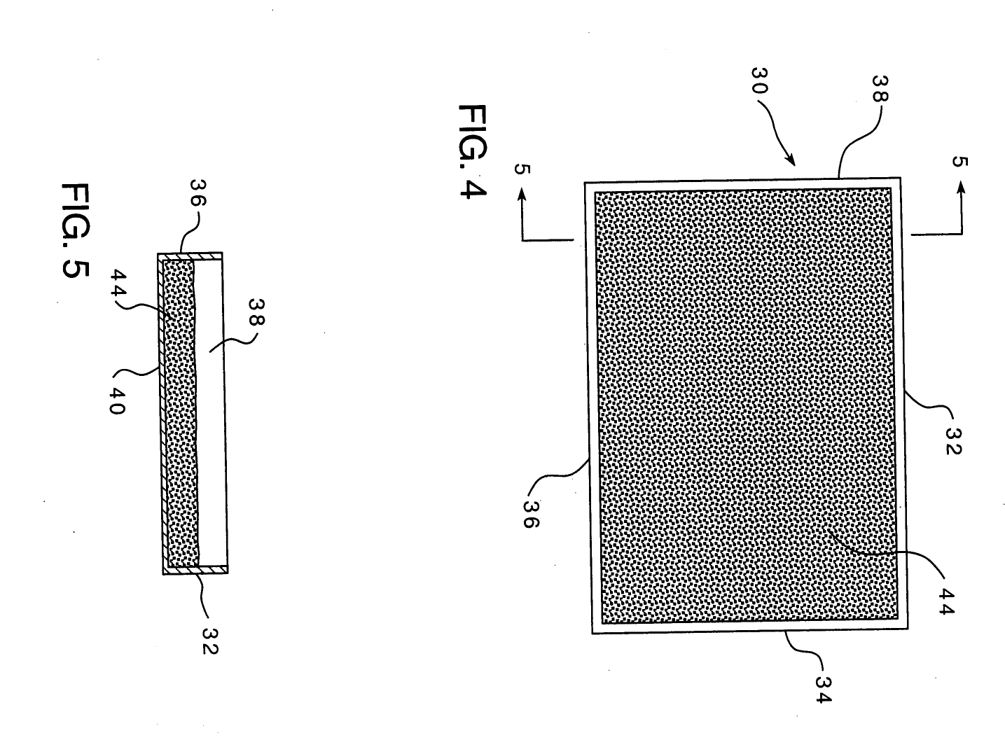

Referring to FIGS. 1 through 3, the cutting guide has an elongated body portion 2 and a depending flange 4 which is preferably oriented generally perpendicularly with respect to the body portion 2. The body portion 2 has a pair of generally straight lateral edges 6, 8 which are parallel to each other. The body portion in the form shown has a plurality of reference markings which are disposed in a preferred form adjacent to the lateral edges 6, 8 of the guide. For example, a first marking 10 has a corresponding second marking 12 and a marking 14 has a corresponding marking 16. Interposed between markings 10, 12 and markings 14, 16 is a marking 20 which extends completely across the body portion 2. Similar markings are shown throughout the elongated extent of the body portion 2. These markings are generally uniformly spaced with respect to next adjacent markings. The numbers such as the number “1”, 22 and “2”, 24 may be measured in inches or in metric units or any other desired dimensional quantities.

While it will be appreciated that the size of the pan and convenience of use will influence the dimensioning of the cutter guide in a preferred embodiment it will have a length L of about 14 to 18 inches, a width W of about 1 to 3 inches and a flange height H of about 1 to 3 inches.

Referring now to FIG. 5, there is shown a rectangular pan 30 which has 4 upstanding sidewalls 32, 34, 36, 38 disposed around the periphery of the pan and a base 40. A food product 44 is positioned within the pan.

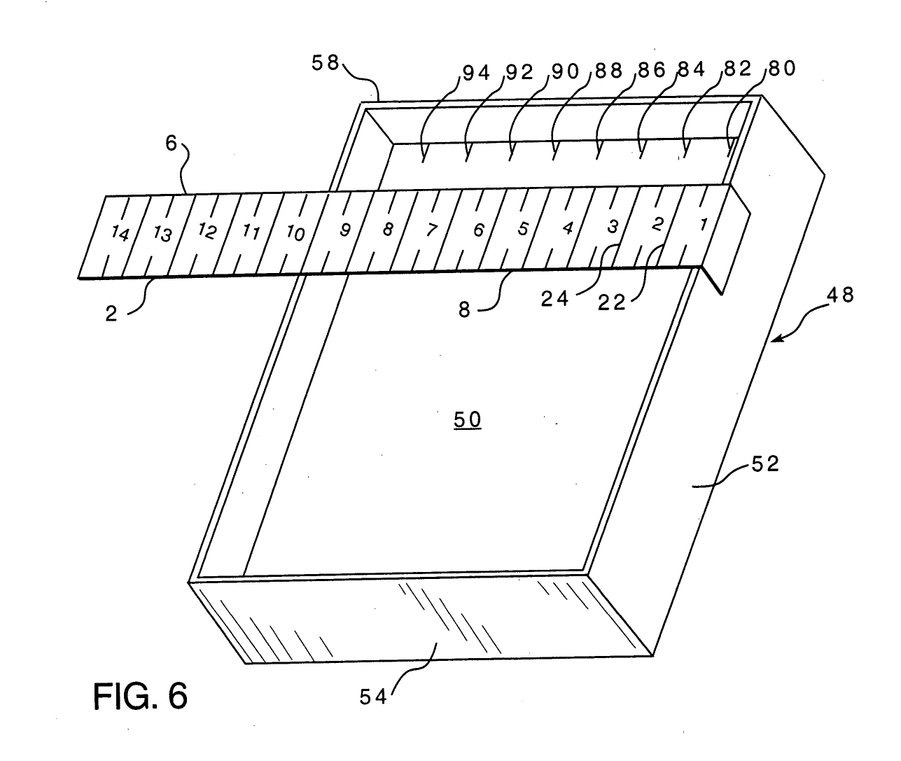

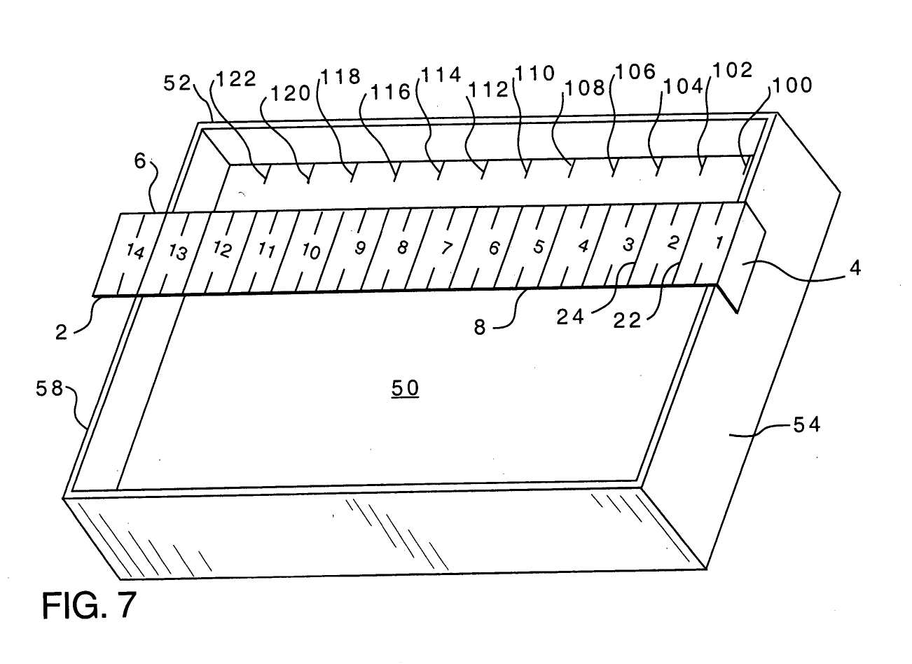

Referring to FIG. 6, there is shown a rectangular pan 48 containing a solid food product 50 and having 4 upstanding sidewalls 52, 54, 56, 58 which are perpendicular to the pan base and are connected to each other so as to establish a continuous peripheral sidewall. The cutting guide 2 which may be identical to that shown in FIGS. 1 through 3 has a flange 4 positioned in surface-to-surface adjacency with sidewall 54 and lateral edge 6 in spaced relationship with respect to sidewall 58, but closely adjacent thereto. The spacing between lateral edge 6 and pan sidewall 58 may, for example, be about ½ inch to 1 inch. It will be seen that a series of cuts or marks or depressions 80, 82, 84, 86, 88, 90, 92, 94 have been provided in the food product 50 adjacent to lateral edge 6 of the cutting guide 60. Each of the marks or cuts 80-94 (even numbers only) is aligned with an associated reference marking on the cutting guide such as reference marking 22 and 24 which are respectively associated with marks or cuts 80 and 82. In this manner, precisely spaced markings are provided on or in the food product 50 in a first direction. After this has been accomplished, as shown in FIG. 7 the cutting guide is lifted and rotated 90° so as to place its lateral edge 6 closely adjacent to and parallel to sidewall 52 with flange 4 in engagement with sidewall 54. In this manner, a series of marks or cuts such as marks or cuts 100, 102, 104, 106, 108, 110, 112, 114, 116, 118, 120 and 122 each associated with a reference mark such as mark “1”, 20 and mark “2”, 24 is provided with the lateral edge 6 preferably spaced about ½ inch to 1 inch from lateral wall 52 in this manner. After these markings have been placed, the lateral edges 6 and 8 may be positioned with respect to marks 80-94 (even numbers only) sequentially to permit using either lateral edge 6 or 8 or both in order to effect cutting in a first direction from sidewall 54, 58 progressively as to each of the markings after which the cutting guide may be positioned as shown in fifth or sixth with the markings 100-122 (even numbers only) being employed to create generally perpendicular cuts. In the form shown employing the reference markings employed in the description herein, it will be appreciated that a plurality of individual portions each being square and of substantially identical dimensions is provided. The cutting guide 60 may then be removed from the pan and the cut portions withdrawn.

While for convenience of disclosure express reference has been made to food products disposed within pans, it will be appreciated that the invention is not so limited. In making and cutting such a food product, the flange may be positioned on the sides of the food product.

It will be appreciated that the cutting guide 60 may be employed to create rectangular individual portions of whatever size allowed or as illustrated, employed in the example square portions. Also in the event of circular food products, such as pieces, for example, wedge shape individual portions may be created.

It will be appreciated that the cutting guide may preferably be made of metal or plastic and would be economical and simple to manufacture and use as well as be easy to clean in order to provide for safety considerations.

Whereas particular embodiments of the invention have been described herein for purposes of illustration, it will be evident to those skilled in the art that numerous variations of the details may be made without departing from the invention as set forth in the upended claims.

1. A method of cutting a food product into portions of predetermined size comprising
providing a substantially rigid cutting guide having an elongated body and a flange,
positioning said cutting guide in a first position on top of a food product adjacent a first side thereof with said flange engaging an adjacent second side,
marking said food product for cutting at a plurality of first spaced locations along said cutting guide,
moving said cutting guide to a second position generally perpendicular to said first position with said flange engaging a side adjacent to said first said wall,
marking said food product for cutting at a plurality of second spaced locations along said cutting guide,
aligning said cutting guide sequentially with said first or second spaced locations and cutting said food product along said guide at said first or second spaced locations, and
subsequently cutting said food product sequentially along said guide of the other of said first and second spaced locations.

2. The method of cutting a food product of claim 1 comprising
effecting said marking and cutting with said food product disposed within a pan.

3. The method of cutting a food product of claim 2 including
said pan having at least one generally planar sidewall.

4. The method of cutting a food product of claim 2 including
providing said cutting guide with a plurality of relatively spaced reference marks.

5. The method of cutting a food product of claim 4 including
providing said reference marks adjacent lateral edges of said cutting guide body portion.

6. The method of cutting a food product of claim 5 including
providing said reference marks on said body portion with generally equal spacing therebetween.

7. The method of cutting a food product of claim 6 including
employing a metal said pan.

8. The method of cutting a food product of claim 2 including
employing a pan having a shape selected from the group consisting of square and rectangular.

9. The method of cutting a food product of claim 2 including
employing said process on baked products.

10. The method of cutting a food product of claim 2 including
after effecting said cutting removing cut individual portions of said food product from said pan.

11. The method of cutting a food product of claim 2 including
providing said cutting guide in a material selected from the group consisting of metal or plastic.

12. The method of cutting a food product of claim 4 including
providing numbers as a portion of said reference marks.

13. The method of cutting a food product of claim 8 including
providing said pan with four upstanding sidewalls which are each generally planar and cooperating to define a substantially continuous pan sidewall.

14. The method of cutting a food product of claim 13 including
providing said cutting guide in said first position in spaced relationship with respect to said first sidewall, and
providing said cutting guide in said second position adjacent to a second sidewall.

15. The method of cutting a food product of claim 1 including
said cutting guide having a pair of generally parallel lateral edges.

16. The method of cutting a food product of claim 1 including
said cutting guide having a body portion which is about 14 to 18 inches long, about 1 to 3 inches wide and a said flange having a height of about 1 to 3 inches.

17. A food cutting guide comprising
an elongated substantially rigid body portion,
a pan-engaging flange depending from said body portion, and
a plurality of reference marks in relative space relationship along at least one lateral edge of said body portion.

18. The food cutting guide of claim 17 comprising
said flange being oriented generally perpendicular to said body portion.

19. The food cutting guide of claim 18 including
said body portion having a length of about 14 to 18 inches.

20. The food cutting guide of claim 19 including
said body portion having a width of about 1 to 3 inches.

21. The food cutting guide of claim 20 including
said flange having a height of about 1 to 3 inches.

22. The food cutting guide of claim 21 including
said flange being integrally formed with said body portion.

23. The food cutting guide of claim 22 including
said food cutting guide being formed of a material selected from the group consisting of metal and plastic.
